(19) United States
(12) Patent Application Publication
(10) Pub. No.: US 2015/0019606 A1
(43) Pub. Date: Jan. 15, 2015

(54) Method for evaluating an output of a random generator

(71) Applicants: Matthew LEWIS, Reutlingen (DE); Eberhard Boehl, Reutlingen (DE); Klaus Damm, Reutlingen (DE)

(72) Inventors: Matthew LEWIS, Reutlingen (DE); Eberhard Boehl, Reutlingen (DE); Klaus Damm, Reutlingen (DE)

(73) Assignee: Robert Bosch GmbH, Stuttgart (DE)

(21) Appl. No.: 14/325,967

(22) Filed: Jul. 8, 2014

(30) Foreign Application Priority Data
Jul. 9, 2013 (DE) 10 2013 213 385.5

(51) Int. Cl. G06F 7/58

(52) U.S. Cl. CPC G06F 7/588; G06F 2207/58
USPC 708/251

(57) ABSTRACT

A method and an assemblage for checking an output of a random generator are presented. In the method, signatures that are respectively created from a sequence of sampled values are compared with one another.

### RELATED APPLICATION INFORMATION

The present application claims priority to and the benefit of German patent application no. 10 2013 213 385.5, which was filed in Germany on Jul. 9, 2013, the disclosure of which is incorporated herein by reference.

### FIELD OF THE INVENTION

The present invention relates to a method for evaluating an output of a random generator, and to an assemblage for carrying out the method.

### BACKGROUND INFORMATION

Random numbers, which are referred to as the result of random elements, are required for many applications. So-called “random generators” are used to generate random numbers. Random generators are methods that supply a sequence of random numbers. A critical criterion for random numbers is whether the result of the generating process can be regarded as independent of previous results.

Random numbers are required, for example, for cryptographic methods. These random numbers are used in order to generate keys for encoding methods. For example, random number generators (RNGs) are used in order to generate master keys for symmetrical encoding methods and protocol handshaking in elliptical curve cryptography (ECC), which prevent a power analysis attack and replay attacks.

There are two basic types of RNGs, namely pseudo-random number generators (PRNGs) for high throughputs and low security levels. In a PRNG usually a secret value is inputted, and each input value will always produce the same output series. A good PRNG, however, will output a series of numbers that appears random and that will withstand most tests.

High standards in terms of random properties are applied to keys for cryptographic methods. Pseudo-random number generators (PRNGs), represented e.g. by a linear feedback shift register (LRFS), are therefore not suitable for this purpose. Only a generator of truly random numbers, referred to as a true random number generator (TRNG), meets the relevant requirements. In this, natural noise processes are used in order to obtain an unpredictable result. Noise generators that utilize the thermal noise of resistors or semiconductors, or the shot noise at potential barriers or at p-n transitions, are usual. A further possibility is to utilize the radioactive decay of isotopes.

While the “classic” methods used analog elements, for example resistors, as noise sources, in the recent past digital elements, for example inverters, have been used. These have the advantage of less complexity in terms of circuit layout, since they exist as standard elements. In addition, such circuits can also be used in user-programmable circuits such as FPGAs.

It is believed to be understood, for example, to use ring oscillators that represent an electronic oscillator circuit. With these, an odd number of inverters is interconnected to form a ring, so that an oscillation having a natural frequency is produced. The natural frequency depends on the number of inverters in the ring, the properties of the inverters, the interconnection conditions (i.e. lead capacitances), operating voltage, and temperature. The noise of the inverters causes a random phase shift to be produced with respect to the ideal oscillator frequency, which is used as a random process for the TRNG. It is noteworthy that ring oscillators oscillate independently and do not require external components such as capacitors or coils.

The output of the ring oscillators is usually compressed or subjected to post-processing in order to compress or bundle (i.e. increase) entropy and eliminate any bias.

A problem in connection with the utilization of randomness is that the ring oscillator must be sampled as close as possible to an expected ideal edge so that a random sampled value is obtained. The publication of Bock, H., Bucci, M., Luzzi, R.: An Offset-Compensated Oscillator-Based Random Bit Source for Security Applications, CHES 2005, indicates how it is possible, by controlled shifting of the sampling point in time, for sampling always to occur in the vicinity of an oscillator edge.

The document EP 1 686 458 B1 discusses a method for generating random numbers with the aid of a ring oscillator, in which a first and a second signal are made available, the first signal being sampled in a manner triggered by the second signal. In the method described, a ring oscillator is repeatedly sampled, in which context only non-inverting delays, i.e. an even number of inverters as delay elements, are always used. The oscillator ring is always sampled, simultaneously or with a mutual delay, after an even number of inverters beginning from a starting point. Shifting of the sampling point in time can thereby be omitted; instead, the multiple sampled signals are evaluated.

The publication “Design of Testable Random Bit Generators” by Bucci, M. and Luzzi, R. (CHES 2005) presents a method with which an influence on the random source can be identified. Attacks can thereby be prevented. A direct distinction between random values and deterministic values is, however, not possible therewith. It is possible to evaluate the quality of the random source by counting the transitions.

A further possibility is provided by the use of multiple ring oscillators. This is presented, for example, in the publication Sunar, B. et al.: A Provable Secure True Random Number Generator with Built In Tolerance to Attacks, IEEE Trans. on Computers, January 2007. Here sampled values of several ring oscillators are combined with one another and evaluated.

In ring oscillators an odd number of inverters is interconnected to form a ring, thereby producing an oscillation having a natural frequency. The natural frequency depends on the number of inverters in the ring, the properties of the inverters, the interconnection conditions (i.e. lead capacitances), operating voltage, and temperature. The noise of the inverters produces a random phase shift with respect to the ideal oscillator frequency, which is utilized as a random process for the TRNG.

An advantageous implementation of a TRNG source using a ring oscillator sampled at multiple points is shown in FIG. 1. This circuit at the same time offers the advantage that a correlation with the system clock can be identified, and faults can be discovered, when particular implementation conditions are present with a uniform capacitive load at all nodes of the ring oscillator, and when the circuit elements used (e.g. flip-flops, inverters) are configured in terms of design so that they react as homogeneously as possible to leading and trailing edges.

The TRNG source as configured does not offer the possibility of measuring entropy, i.e. the degree of randomness. For stringent requirements, however, a continuous test of entropy is necessary. In the publication of Bucci, M. and Luzzi, R., no direct distinction is made between randomness and determinism; instead only an estimate of the entropy is performed. Therein the source is also not tested directly, but only after post-processing. This has the disadvantage that specific requirements in terms of post-processing must be applied (stateless), and a distinction must be made between testing (test mode) and actual random number generation.

### SUMMARY OF THE INVENTION

In light of the above, a method having the features described herein and an assemblage in accordance with the features described herein are presented. Further embodiments are evident from the further description herein.

The method presented and the above-described circuit assemblage make possible an online test of the entropy at a TRNG source. This is accomplished in that the TRNG source is connected directly to a testing device and the test takes place before any post-processing that is provided for. A continuous estimate of the quality of the TRNG source is thereby possible. If a specific degree of randomness is not achieved, utilization of the random generator can be automatically prevented. The test occurs independently of the type of post-processing of the random signal, and is not subject to any restrictions with regard thereto.

A multiple input signature register (MISR), which creates a unique signature from a sequence of input bits and thus represents a unit for creating a signature from a sequence of sampled values, can be used, for example, in the method. If two outputted signatures differ, it can be concluded therefrom that the input bit sequences inputted in order to generate the signatures likewise differ from one another. An identical sequence of input bits creates the same signature. A “signature” is understood here not as a digital signature in the context of security requirements, which serves for authentication and is intended to preclude forgery, but merely as a property of the bit sequence which in this case is identified via MISR.

Further advantages and embodiments of the invention are apparent from the description and the appended drawings.

It is understood that the features recited above and those yet to be explained below are usable not only in the respective combination indicated, but also in other combinations or in isolation, without departing from the scope of the present invention.

### BRIEF DESCRIPTION OF THE DRAWINGS

FIG. 1 shows an embodiment of a ring oscillator.

FIG. 2 shows an embodiment of the assemblage for carrying out the method.

FIG. 3 is a flow chart showing an embodiment of the method.

FIG. 4 shows a further embodiment of the assemblage for carrying out the method.

FIG. 5 shows a random source having a testing device.

FIG. 6 is a flow chart showing a further embodiment of the method.

FIG. 7 shows yet another embodiment of the assemblage for carrying out the method.

FIG. 8 is a flow chart showing yet another embodiment of the method.

### DETAILED DESCRIPTION

The system is schematically depicted in the drawings on the basis of embodiments, and will be described in detail below with reference to the drawings.

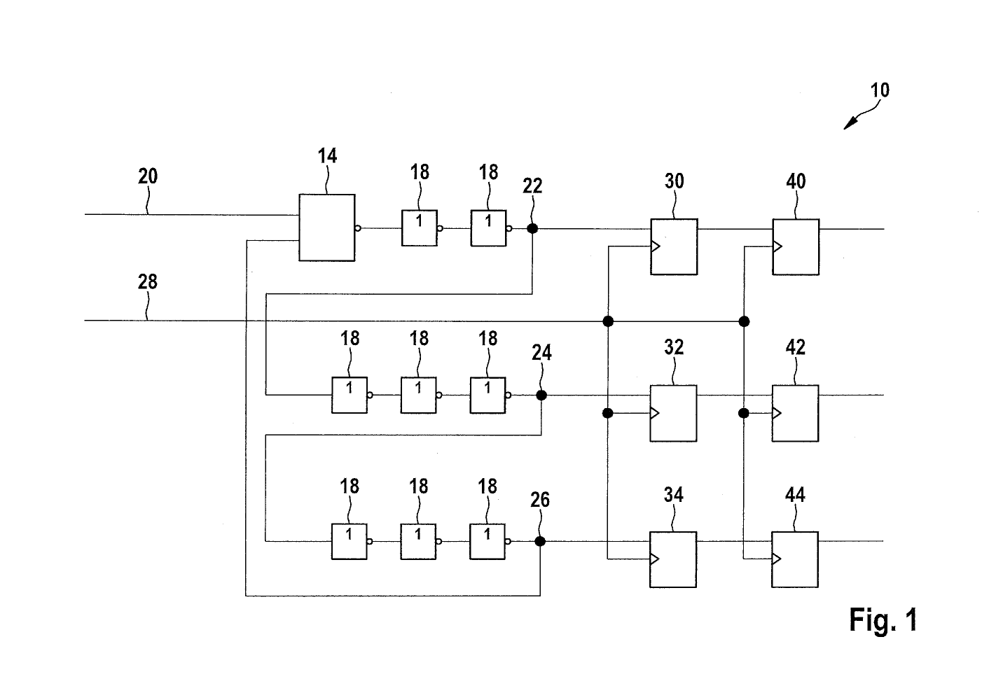

FIG. 1 shows an embodiment of a ring oscillator that is labeled in its entirety with the reference number 10. Ring oscillator 10 has a NAND element 14 and eight inverters 18, and thus nine inverting elements. Ring oscillator 10 thus has an odd number of inverting elements and three pickoffs or sampling points.

Ring oscillator 10 can be started and stopped with a first input 20. The depiction furthermore shows a first sampling point 22, a second sampling point 24, and a third sampling point 26. The sampling rate is defined via a second input 28. This means that beginning from first sampling point 22, a sampling action always occurs after an odd number of inverting elements. This is not absolutely necessary, however, for the method presented.

First sampling point 22 is sampled using a first flip-flop 30, yielding the sampled value s10. Second sampling point 24 is sampled using a second flip-flop 32, yielding the sampled value s11. Third sampling point 26 is sampled using a third flip-flop 34, yielding the sampled value s12. First flip-flop 30 has a further, fourth flip-flop 40 associated with it. This performs a memory function, and outputs the value s10′ that follows the value s10 in time, i.e. s10 and s10′ are chronologically successive sampled values of first sampling point 22. Correspondingly, second flip-flop 32 has associated with it a fifth flip-flop 42 that outputs s11′, and third flip-flop 34 has associated with it a sixth flip-flop 44 that outputs s12′. Flip-flops 40, 42, and 44 are suitable for resolving metastable states of flip-flops 30, 32, and 34. Metastable states arise from the fact that a switchover of the signal at input 28 occurs during an edge at the respective sampling point 22, 24, or 26. Flip-flops 30, 32, and 34 then require a certain time until a stable final state is reached. In the present example, that time is guaranteed by the fact that it is not until the next active edge of the signal at input 28 that the now-stable value of flip-flops 30, 32, and 34 is transferred into flip-flops 40, 42, and 44.

Ring oscillator 10 can thus in principle be constructed from, for example, nine inverters 18. One of these inverters 18 can be replaced by NAND element 14 in order to allow ring oscillator 10 to be stopped. Alternatively, this NAND element 14 can also be replaced by a NOR element.

In the embodiment shown, the values of ring oscillator 10 are stored simultaneously, each in one flip-flop (FF) 30, 32, 34, at three different inverters. These pickoffs are intended to be distributed as regularly as possible over the elements of ring oscillator 10. For the case of nine inverting stages in ring oscillator 10, a pickoff or a sampling point 22, 24, 26 is therefore provided after each three inverting elements. As already mentioned, however, this is not necessary for the method presented. It is also possible to provide a pickoff again after an even number of inverting elements.

The number of inverter stages in ring oscillator 10 determines the frequency of the oscillator, and should therefore be selected so that the flip-flops can store the respective signal value. If an oscillator frequency that is as high as possible is used, the probability of being in the vicinity of an edge when sampling is higher. The number of inverters in the oscillator ring is therefore selected to be as small as possible, but still large enough that the flip-flops are functional for the frequency attained. For a 180-nm technology, a frequency of approximately 1 GHz for ring oscillator 102 having nine inverters 18 was determined by simulation. The flip-flops can store the signal values at this frequency, as has been demonstrated.

The method presented can be carried out with ring oscillator 10 according to FIG. 1 that has an odd number of inverting elements, values being picked off at least two sampling points of the ring oscillator, and an odd number of inverting elements being present in each case between at least two directly successive sampling points.

A correlation with the system clock and thus with the sampling clock cycle obtained therefrom can be identified for ring oscillator 10. Not all correlations can identified here by comparing s10, s11, s12 to s10′, s11′, s12′, even if the divisor value of the frequency divider is divisible by the number of inverting elements in the oscillator ring. It can happen that after a particular arbitrary (optionally constant) number of sampling actions, sampling keeps occurring at the same position in the oscillator cycle. If that number is not simultaneously a divisor of the number of inverting elements in the oscillator, the comparison described above does not yield any information as to the correlation that exists. It is nevertheless possible to identify the correlation when all the samples are compared with the current sample. This is, however, very laborious.

For the ring oscillator in accordance with FIG. 1 having, for example, nine inverters and three sampling points, the bit values stored at the sampling points generally change by at least one bit value after not too large a number of samples. A large number of successive identical bit values is detected by counting warnings, and either a fault is signaled or an influence is exerted on the frequency of the oscillator.

It can therefore be assumed that the sampled values change in such a way that over the course of time in one cycle, other values (typically intermediate values) are also sampled between identical sampled values, namely a starting value equal to a final value, before the final value is reached. For the case in which the starting value and final value are obtained under identical conditions (the phase relationships between the oscillator clock and sampling clock), the same cycle as before would occur for a further cycle, namely final value equal to new starting value, if what is involved is a deterministic process. In the case of a non-deterministic system, however, not every intermediate value between the starting value and final value will typically be identical. This is precisely what is desired in a TRNG, and is then utilized here according to the present invention in order to ascertain randomness.

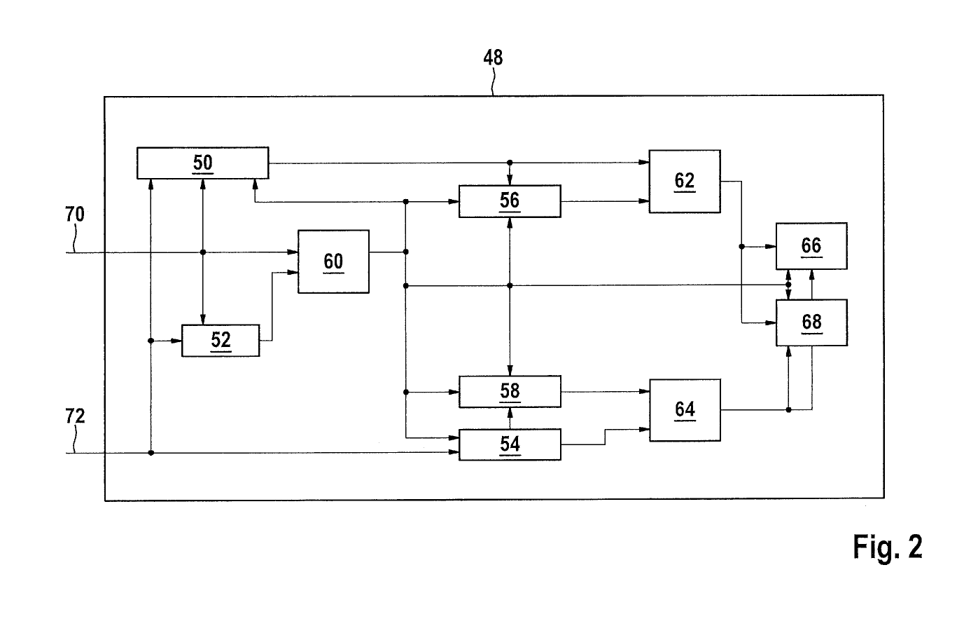

For this purpose, it is proposed that all sampled values between a starting value and a final value, namely the intermediate values, enter into a signature, a change of only one bit in a sampled value resulting, for an execution sequence that is otherwise identical in the cycle, in a different signature. A signature of this kind is obtained, for example, when the sampled values are used as inputs to a multiple input signature register (MISR). Reference is made to FIG. 2 regarding this.

FIG. 2 shows an assemblage 48 in which signature creation is accomplished using an MISR. The illustration shows an MISR 50, a starting value register 52, a sample counter 54, a signature register memory 56, a sample counter memory 58, comparators 60, 62, and 64, an entropy counter 66, and a warning counter 68. A first input 70 serves for the input of s0, s1, and s2, which can be identical to s10′, s11′, and s12′ of FIG. 1. A second input 72 serves for input of the start request.

Because MISR 50 is implemented with linear coupling of the inputs into a linearly fed-back shift register, each change in a bit results in a change in the overall signature. If the signature of a first cycle is then compared with that of a subsequent one, and if a change is ascertained, it can then be assumed in some circumstances that at least one bit value of a sampled value differs in one of the two cycles. It is also important in this context that the number of sampled values between the starting value and final value be the same.

Due to a phase shift at the starting value it can happen that one more or one less sampled value results in the final value. An additional sampled value would cause the signature to change even if all the other values were identical. This change is then not attributable to a random process, however, and should therefore not be taken into account.

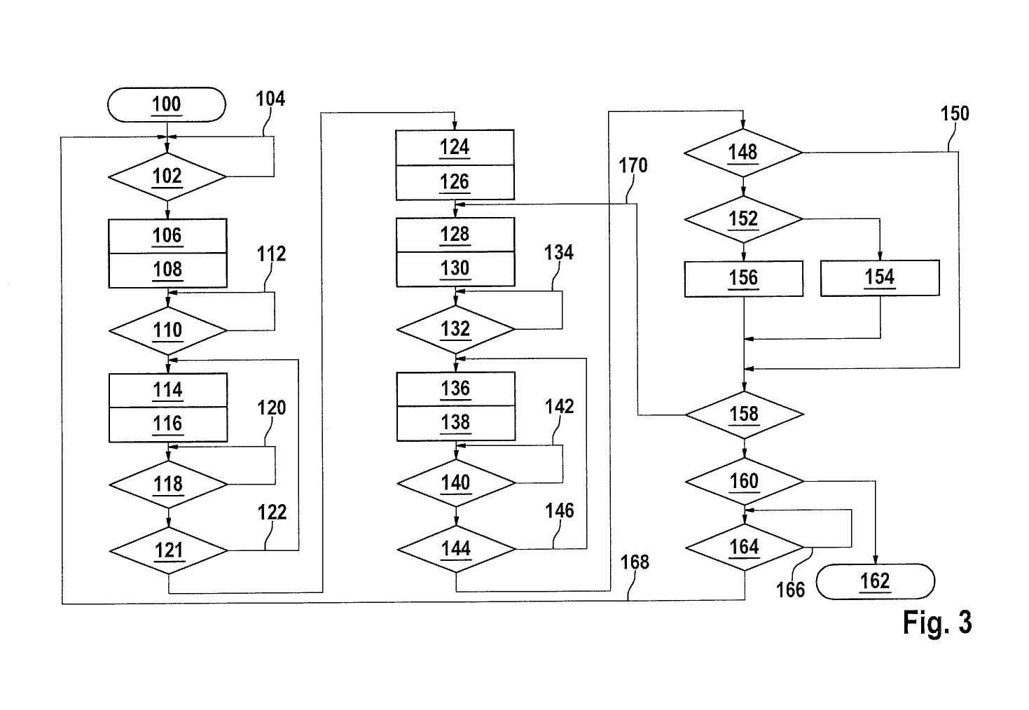

The execution sequence depicted in FIG. 3 is therefore provided. Startup occurs in step 100. A next step 102 checks whether the input is valid. If not (arrow 104), execution waits for another input. If the input is valid, in a step 106 the sample counter is set to 0. In a step 108 the starting sampled value is set to the value of the input.

A next step 110 checks whether the input corresponds to the starting sampled value. If so, execution loops back (arrow 112). If not, in a step 114 the sample counter is incremented, and in a step 116 the input value enters into the MISR signature. “Enters into” is understood to mean that at various points in the MISR, the input signals are XORed with the output values of the flip-flops of the MISR, these logically combined signals are used as input signals of another flip-flop of the MISR, and then a shift operation with a corresponding feedback function is carried out. An operation of this kind is known in principle.

A step 118 then checks whether a new sample is present. If not, execution loops back (arrow 120). If so, a step 121 checks whether the input corresponds to the starting sampled value. If not, execution loops back (arrow 122). If so, then in a step 124 the signature generated in the MISR is stored in the signature register, and in a step 126 the value of the sample counter is stored in the sample counter register. Then in a step 128 the MISR is set to 0, and in a step 130 the sample counter is set to 0.

A step 132 then checks whether the input corresponds to the starting sampled value. If so, execution loops back (arrow 134). If not, in a step 136 the sample counter is incremented, and in a step 138 the input values enters into the MISR signature. A step 140 then checks whether a new sample is present. If not, execution loops back (arrow 142). If so, a step 144 then checks whether the input corresponds to the starting sampled value. If not, execution loops back (arrow 146). If so, a next step 148 checks whether the sample counter is equal to the contents of the sample counter register. If not, the next steps are skipped (arrow 150). If so, a step 152 then checks whether the signature register corresponds to the MISR. If not, in a step 154 the entropy counter is incremented. If so, then in a step 156 the warning counter is incremented.

A step 158 then queries whether the method is to be continued. If not, a step 160 queries whether a new method is to be carried out. If not, the method is then terminated in a step 162. If so, a step 164 checks whether the input corresponds to the starting sampled value. If so, execution loops back (arrow 166). If not, execution loops back to the beginning (arrow 168). If the result of the query in step 158 is that the method is to be continued, execution loops back (arrow 170).

The execution sequence of the method, with the states as set forth, is therefore as follows:
0. Test whether the input assignment is permissible (for example, “000” or “111” might not be permissible).
1. Store the instantaneous sampled value as a starting value in starting value register 52. Set a counter (54) and an MISR (50) to an initial value, e.g. all memory elements=0.
2. Test repeatedly, using comparator 60, whether the next sampled value diverges from the starting value.
3. With the first divergent sampled value and every following sampled value, the counter (54) is incremented and at the same time the sampled values enter into a signature (MISR 50).
4. When the final value is reached, i.e. sampled value equal to starting value (comparator 60), store the signature in signature register memory 56 and the counter status in sample counter memory 58.
5. Set counter 54 and MISR 50 back to the initial value.
6. Test repeatedly, using comparator 60, whether the next sampled value diverges from the final value=starting value.
7. With the first divergent sample value and each following sampled value, counter 54 is incremented and at the same time the sampled values enter into a signal (MISR 50).
8. When the final value is reached, i.e. sampled value equal to starting value (comparator 60), compare the signature (using comparator 62) and counter status (using comparator 64) with the respective stored values:
   a) If the counter status is the same and signature value different: increment entropy counter 66.
   b) If the counter value and signature value are the same: increment a warning counter 68.
   c) If the counter value is different, leave these two (evaluation) counters 66 and 68 unchanged.
9. Go either to state 5 or, after reaching a new starting value, to state 1.

The branching to item 5 or 1 can be made dependent on what the respective values are in the entropy counter and warning counter, or a fixed number of execution sequences having the same starting value can also be defined. After a defined time period the two evaluation counters 66 and 68 can be compared with setpoint values, and a randomness value and thus the quality of the TRNG source can be identified therefrom.

Be it noted that that the entropy value ascertained using this method defines a lower limit, namely a minimum value. This is, however, precisely what is desired for a TRNG, since a reliable proportion of randomness can thereby be taken into account. If this value falls below a limit, further actions can be taken, for example shutting off the generator, influencing the oscillator frequency, or outputting an error. The same kind of reaction can occur if the warning counter exceeds a defined value. The pessimistic entropy evaluation results from the fact that the starting value and/or final value are modified by randomness, or also that, as described above, the number of sampled values between the starting value and final value can vary.

Random values that occur in these execution sequences are not reflected in the entropy counter. It is therefore important to evaluate the warning counter in combination with the entropy counter. A low warning counter value, even with a low entropy counter value, cannot rule out the possibility that the random source has a high quality; conversely, a high warning counter value with a low entropy counter value indicates a fairly low TRNG quality. The comparison values should be as configurable as possible so that the test can be adapted to different technologies.

In a further embodiment of the invention, instead of an MISR for creating a signature it is also possible to use a counter of the transitions of each bit value, a so-called “edge counter.” For this, for example, the zero-one transition, one-zero transition, or both transitions are counted, for each bit, during one cycle between the starting value and final value. Not only does this reveal whether a difference exists between two otherwise identical cycles, but the number of bit changes can also be identified. The entropy counter is then incremented by an amount equal to the sum of the differences of the three sampled bit values. Care must be taken here that the differences are in each case regarded as positive values. In a further generalization, the number of ones in the output signal in one period can be counted, and compared with the number of ones in at least one further period.

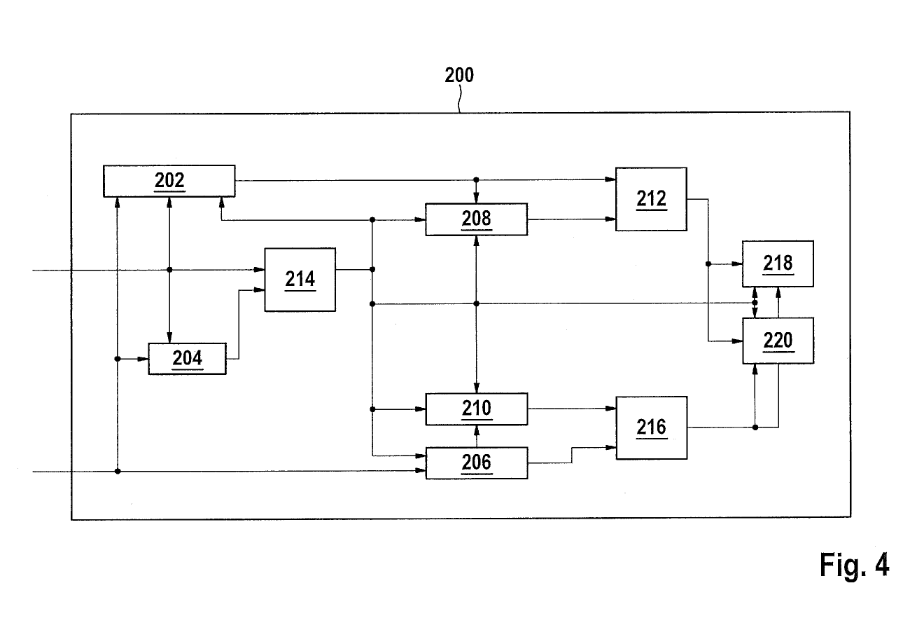

An assemblage for bitwise counting of the transitions, with comparison and evaluation, is depicted in FIG. 4. The assemblage, labeled in its entirety with the reference number 200, encompasses a counter 202 for bitwise counting of the transitions, a starting value register 204, a sample counter 206, a memory 208 for the transition values, a sample counter member 210, an element 212 for calculating a difference between the transition counters, a first comparator 214 and a second comparator 216, an entropy counter 218, and a warning counter 220.

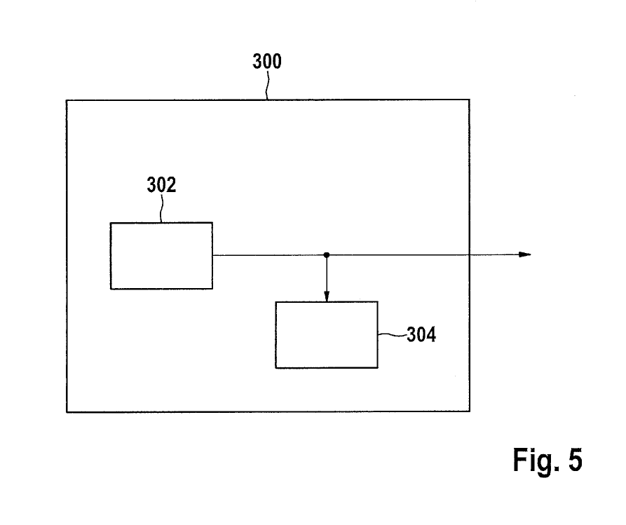

An assemblage for post-processing is reproduced, for example, in FIG. 5, identified with the reference number 300. The depiction shows a TRNG source 302 that is connected to a testing device 304.

For an output signal sequence, the number of ones, the number of zero-one transitions, of one-zero transitions, or the signature that is created by way of an MISR, are properties of the signal profile. If one bit in that signal profile is replaced with the inverse value, the signal sequence then has different properties. For example, the modified bit generates a different signature, the number of ones changes, and the number of transitions can also change. It is not obligatorily necessary for the property to change for each change in the signal profile, since there is no requirement in terms of the test of properties that all changes in fact be detected. It is simply necessary to detect a minimum number of changes, and thus a lower limit of the degree of randomness. For example, the fact that the number of transitions does not change when one bit in the signal profile changes is to be ignored. The number of bits in the MISR signature register also does not need to be selected to be so large that two different signal profiles cannot result in the same signature (aliasing). Depending on the length of the signal sequence, even a small signature width is therefore sufficient in some circumstances to allow detection of a minimum degree of randomness.

Further properties that can apply are the maximum number of constant signal values, the directly successive zeroes or ones, the occurrence of a zero-one-zero or one-zero-one transition, or the length of a sequence having constantly alternating signal values.

It is furthermore to be noted that according to the embodiment as shown in FIG. 1, the bit values “000” and “111” possibly do not occur as inputs. The reason for this is that the oscillator itself cannot have identical values simultaneously at the three relevant sampling points. As simulations and measurements on a chip have shown, such “forbidden” values are nevertheless possible if the sampling flip-flops for s10, s11, and s12 have different charge reversal times for the internal state from 0 to 1 and from 1 to 0. In the case observed, the 0 to 1 reversal in the flip-flop was appreciably slower than the 1 to 0 reversal. The result is that the internal state 0 occurs more often than the state 1. Because an inversion section is additionally connected between the internal state and the output of the flip-flop, the state 1 occurs more often at the output of the flip-flop. The consequence of this is that the state “111” occasionally occurs, while “000” was never observed. It is not, therefore, that the state “111” should be evaluated as “forbidden,” but merely that a test for “000” should occur. In a different implementation it is also possible for the sequence “000” to occur.

Careful consideration should nevertheless be given as to whether “000” or “111” is permitted as a starting value for signature creation. The execution sequence diagram in FIG. 3 has incorporated into it for this purpose an additional query after startup as to whether the input is valid, i.e. is not “000” or “111”. In this case execution should be delayed until a “valid” starting value is present.

The above-described test according to the present invention is useful principally when the period lengths do not change so often. In the contrary case, a test could be carried out only very infrequently, specifically when the period lengths are identical twice in succession. As shown by practical measurements on a test chip, this can also occur very seldom under specific conditions. This method is then perhaps that much less suitable. In a further generalization, it is therefore advantageous if signature values for different cycle lengths can also be stored, and the calculated signature is compared with a stored signature for the same period length.

This would require furnishing a memory field having n elements of approximately 4 to 8 bits each. The value for n could be selected in the range of a few tens, for example 16 or 32. It must always be remembered that in the case of a small divergence of the oscillator frequency from a multiple of the sampling frequency, the cycles can occasionally also become long. Because such things can be discovered and dealt with in the method, however, it is also possible for such frequency ratios to be avoided, or these seldom-occurring events are not incorporated into the evaluation. If the evaluation of long cycles is not to be omitted, it is advantageous to provide a RAM as a memory field. When the test run is restarted with a new starting value, it is important for all the elements in the memory field to be erased. The signature generated is stored in the memory in accordance with the current counter status (address), and in the context of a comparison the comparison value corresponding to the counter status is retrieved from the memory. If the comparison value is (still) zero, no comparison takes place, and instead only the current signature is stored. If the comparison value is different from zero, the comparison of the current signature with the stored one takes place, and then the current signature is written into the memory field.

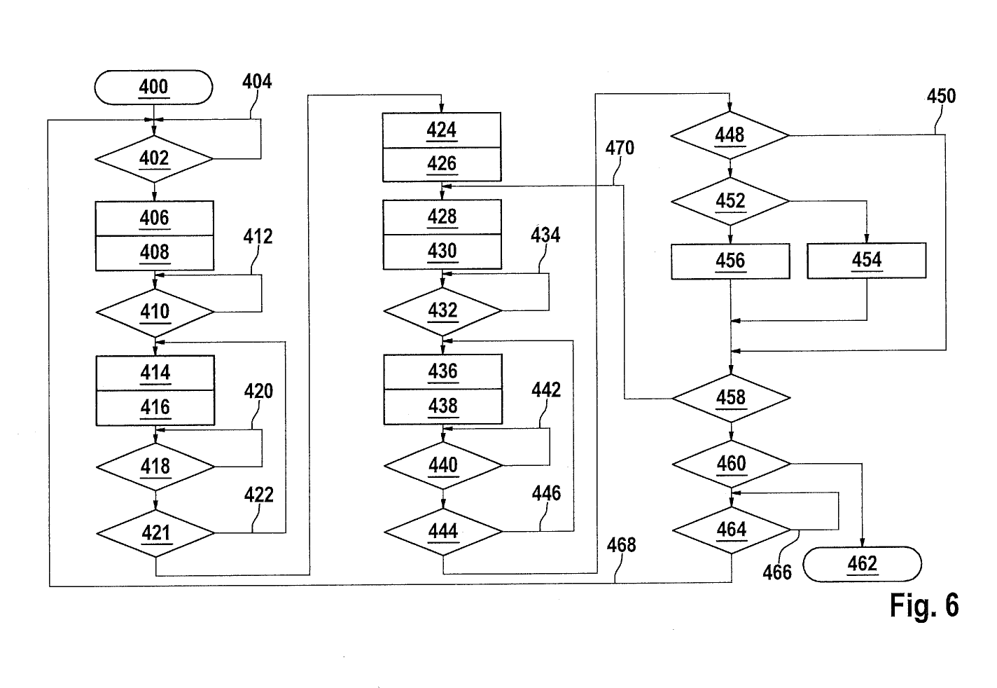

FIG. 6 shows a further possible execution sequence of the method using an edge counter. Startup occurs in a step 400. A next step 402 checks whether the input is valid. If not (arrow 404), execution waits for another input. If the input is valid, the edge counter is set to 0 in a step 406. In a step 408 the starting sampled value is set to the value of the input.

A next step 410 checks whether the input corresponds to the starting sampled value. If so, execution loops back (arrow 412). If not, in a step 414 the sample counter is incremented. and in a step 416 the edge counter is incremented by an amount equal to the number of edges present.

A step 418 then checks whether a new sample is present. If not, execution loops back (arrow 420). If so, a step 421 then checks whether the input corresponds to the starting sampled value. If not, execution loops back (arrow 422). If so, in a step 424 the edge counter is stored in the edge counter register, and in a step 426 the sample counter is stored in the sample counter register. Then in a step 428 the edge counter is set to 0, and in a step 430 the sample counter is set to 0.

A step 432 then checks whether the input corresponds to the starting sampled value. If so, execution loops back (arrow 434). If not, in a step 436 the sample counter is incremented, and in a step 438 the edge counter is incremented by an amount equal to the number of edges present. Then a step 440 checks whether a new sample is present. If not, execution loops back (arrow 442). If so, then a step 444 checks whether the input corresponds to the starting sampled value. If not, execution loops back (arrow 446). If so, a next step 448 checks whether the sample counter is equal to the content of the sample counter register. If not, the next steps are skipped (arrow 450). If so, a step 452 then checks whether the edge counter register corresponds to the edge counter. If not, in a step 454 the entropy counter is incremented. If so, then in a step 456 the warning counter is incremented.

A step 458 then queries whether the method is to be continued. If not, a step 460 then queries whether a new method is to be carried out. If not, the method is then terminated in a step 462. If so, a step 464 checks whether the input corresponds to the starting sampled value. If so, execution loops back (arrow 466). If not, execution loops back to the beginning (arrow 468). If the result of the query in step 458 is that the method is to be continued, execution then loops back (arrow 470).

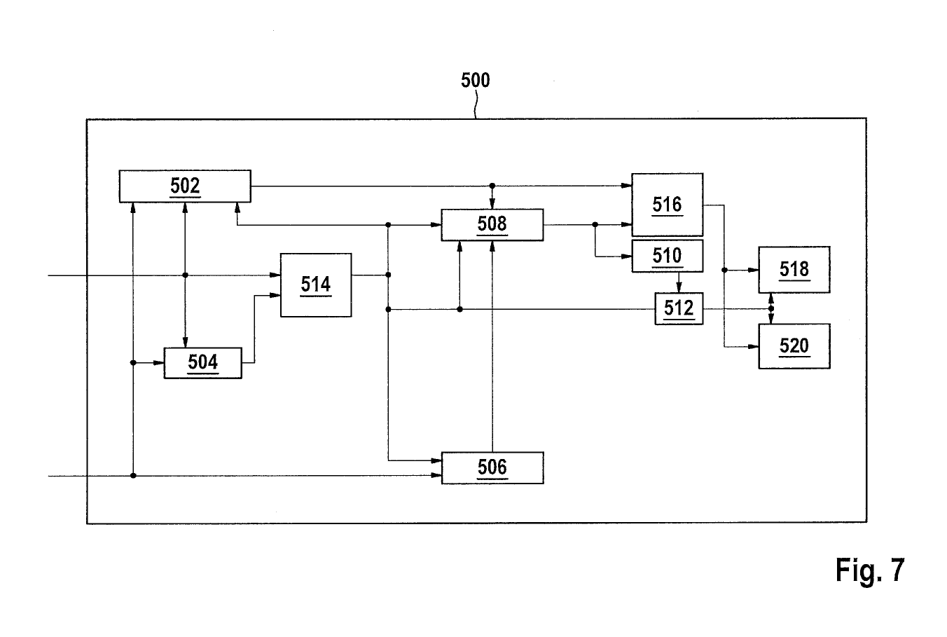

FIG. 7 shows a further assemblage for signature creation using an MISR, labeled in its entirety with the reference number 500. This assemblage 500 encompasses an MISR 502, a starting value memory 504, a sample counter 506, a signature register memory field 508, a zero detector 510, a write blocker 512, a first comparator 514, a second comparator 516, an entropy counter 518, and a warning counter 520.

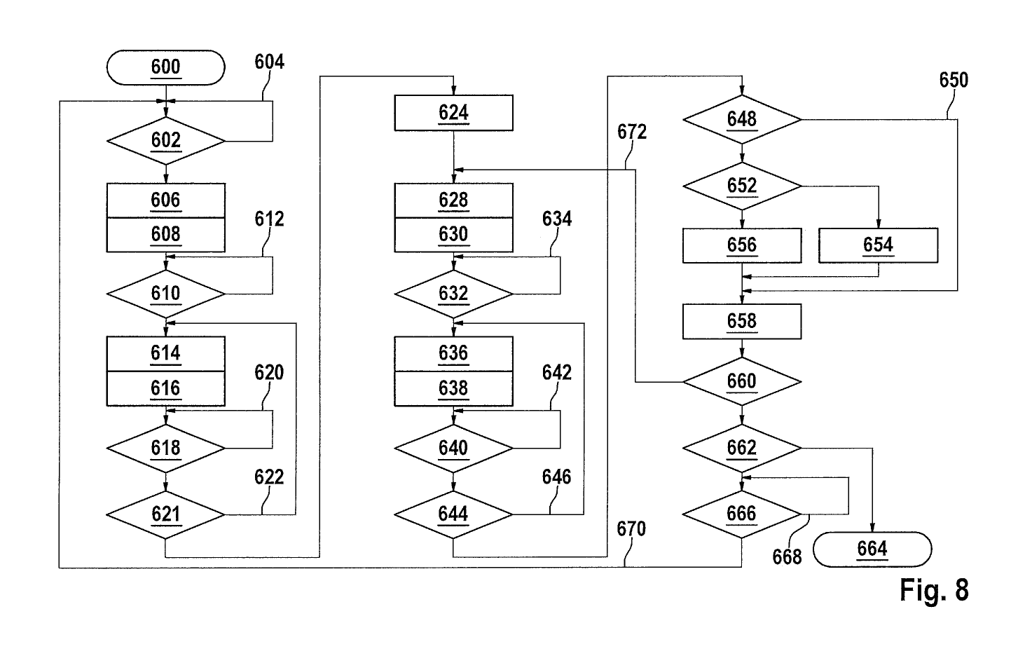

The fact that the signature in the initial state must be reset to “zero” can be a limitation: it is therefore presumed, even for every “zero” signature generated, that no signature has yet been created. In a further embodiment of the invention it is therefore also possible, instead of the query as to the zero comparison value, to query a status bit. For this, a status bit is provided for each counter value, which bit is set when the corresponding comparison value is first written. All status bits are reset to 0 at the beginning or at a restart. The following modified execution sequence for the assemblage modified in accordance with FIG. 7 is therefore provided, as illustrated in FIG. 8.

The execution sequence depicted in FIG. 8 is therefore provided. Startup occurs in a step 600. A next step 602 checks whether the input is valid. If not (arrow 604), execution waits for another input. In the input is valid, in a step 606 the sample counter, the MISR, and the signature register field are set to 0. In a step 608 the starting sample value is set to the value of the input.

A next step 610 checks whether the input corresponds to the starting sample value. If so, execution loops back (arrow 612). If not, in a step 614 the sample counter is incremented, and in a step 616 the input value enters into the MISR signature.

Then a step 618 checks whether a new sample is present. If not, execution loops back (arrow 620). If so, a step 621 checks whether the input corresponds to the starting sampled value. If not, execution loops back (arrow 622). If so, in a step 624 the value of the MISR is stored in the signature register field. Then in a step 628 the MISR is set to 0, and in a step 630 the sample counter is set to 0.

A step 632 then checks whether the input corresponds to the starting sample value. If so, execution loops back (arrow 634). If not, in a step 636 the sample counter is incremented, and in a step 638 the input value enters into the MISR signature. A step 640 then checks whether a new sample is present. If not, execution loops back (arrow 642). If so, a step 644 then checks whether the input corresponds to the starting sample value. If not, execution loops back (arrow 646). If so, then a next step 648 checks whether the value of the signature register field corresponding to the counter value of the sample counter is equal to 0. If not, the next steps are skipped (arrow 650). If so, a step 652 checks whether the entry in the signature register field corresponding to the counter value of the sample counter corresponds to the MISR. If not, in a step 654 the entropy counter is incremented. If so, in a step 656 the warning counter is incremented.

In a step 658 the value of the MISR is then stored in the corresponding element of the signature register field. Then a step 660 queries whether the method is to be continued. If not, a step 662 queries whether a new method is to be started. If not, in a step 664 the method is terminated. If so, a step 666 checks whether the input corresponds to the starting sampled value. If so, execution loops back (arrow 668). If not, execution loops back to the beginning (arrow 670). If the result of the query in step 660 is that the method is to be continued, execution loops back (arrow 672).

In an embodiment, the method thus proceeds as follows:
0. Test whether the input assignment is permissible (e.g. “000” or “111” could be impermissible).
1. Store the instantaneous sampled value as a starting value. Set a counter and an MISR to an initial value (e.g. all memory elements=0). Erase the memory field or the corresponding status bits.
2. Test repeatedly whether the next sampled value diverges from the starting value.
3. With the first divergent sampled value and each following sampled value, the counter is incremented and at the same time the sampled values enter into a signature (MISR).
4. When the final value is reached (sampled value equal to starting value), store the signature in the memory field using the counter status as address (serial index of the memory field) and set the status bit as applicable.
5. Set the counter and MISR back to the initial value.
6. Test repeatedly whether the next sampled value diverges from the final value (=starting value).
7. With the first divergent sampled value and each following sampled value, the counter is incremented and at the same time the sampled values enter into a signature (MISR).
8. When the final value is reached (sampled value equal to starting value), retrieve the stored signature corresponding to the current counter status as index from the memory field, and test whether it is equal to zero, or test the corresponding status bit. If the retrieved signature is zero or if the status bit=0, go to step 10; otherwise to step 9.
9. Compare the signature in the comparator with the signature retrieved in item 8:
   a) If the signature value is different: increment an entropy counter.
   b) If the signature value is the same: increment a warning counter.
10. Store the signature in the memory field using the counter status as address (serial index), and set the corresponding status bit.
11. Go either to state 5 or, after reaching a new starting value, to state 1.

With this variant it is useful to carry out as many tests as possible using the same starting value, so that the memory field becomes correspondingly filled. In a generalization, instead of the signature values other properties of the signal sequences can also be stored in the memory field and compared with current properties of the signal sequence.

Using the method on data, a high rate of change in signal sequences of identical length can be ascertained. The method is therefore usable effectively in order to measure the randomness rate (entropy).

Also presented is a circuit assemblage having a random source and a test assemblage, the random source generating an output signal that is made up of at least two binary signals, and the test assemblage ascertaining whether at least one output signal assignment occurs more than once and whether at least one other assignment occurs between said identical output signal assignments, thus resulting in a cycle having an initial value, at least one intermediate value that is not identical to the initial value, and a final value that conforms to the initial value, and the test assemblage generates and stores properties of the signal sequence of the output signal in that cycle.

The test assemblage can ascertain whether at least two cycles having the same initial value are present.

The test device can furthermore test whether the number of intermediate values of one cycle is equal to the number of intermediate values of a previous cycle having the same initial value.

The test assemblage can ascertain whether the properties of the signal sequences of these two cycles are identical. The test assemblage can furthermore create a signature by way of the intermediate values and compare it with a stored signature that was generated in a cycle having an identical initial value and an identical number of intermediate values.

The test assemblage can furthermore count, for each input bit, the number of transitions of the intermediate values with respect to one another and to the final value in the cycle, and compare it with a stored value that was generated in a cycle having an identical initial value and an identical number of intermediate values.

If the number of intermediate values of two cycles is identical and additionally the properties of said intermediate values are identical, a warning can be outputted and this can increment a warning counter.

If the number of intermediate values of two cycles is identical and the properties of said intermediate values are not identical, an entropy counter can be incremented or increased by a value resulting from the difference in the properties of the signal sequences.

In addition, the entropy counter and/or the warning counter can be used to evaluate the properties of the TRNG source.

What is claimed is:

1. A method for checking an output of a random generator that is constructed as a ring oscillator, including an assemblage for testing, the method comprising:
providing an output of the random generator that is made up of a sequence of sampled values, in which all of the sampled values between a starting value and a final value in one cycle enter into a signature;
comparing signatures of at least two cycles with one another; and
ensuring that the number of sampled values between a starting value and a final value of the at least two cycles is identical.

2. The method of claim 1, wherein an MISR that creates a signature from a sequence of sampled values is used to create the signature.

3. The method of claim 1, wherein a counter of the transitions of each bit value, which creates a signature from a sequence of sampled values, is used for signature creation.

4. The method of claim 1, wherein a counter of the numbers of ones of each bit value, which creates a signature from a sequence of samples values, is used for signature creation.

5. The method of claim 1, wherein the starting value corresponds to the final value.

6. The method of claim 1, wherein a post-processing is carried out after testing.

7. The method of claim 1, wherein a check is made as to whether the starting value is valid.

8. The method of claim 1 wherein an entropy counter is incremented when it is ascertained that the at least two signatures are different.

9. The method of claim 1, wherein a warning counter is incremented when it is ascertained that the at least two signatures are identical.

10. The method of claim 1, wherein a check is made at to whether the first sampled value after the starting value differs from that starting value.

11. An assemblage for testing an output of a random generator that is constructed as a ring oscillator, comprising:
a unit for creating a signature from a sequence of sampled values; and
a comparator for comparing signatures;
wherein the unit is operable for checking an output of the random generator that is constructed as a ring oscillator, including an assemblage for testing, by performing the following:
providing an output of the random generator that is made up of the sequence of sampled values, in which all of the sampled values between a starting value and a final value in one cycle enter into a signature;
comparing the signatures of at least two cycles with one another; and
ensuring that the number of sampled values between a starting value and a final value of the at least two cycles is identical.
